(19) United States
(12) Patent Application Publication
(10) Pub. No.: US 2025/0296266 A1
(43) Pub. Date: Sep. 25, 2025

(54) INTELLIGENT EJECT DIRECTION DETERMINATIONS FOR INJECTION MOLD DESIGNS

(71) Applicant: Siemens Industry Software Inc., Plano, TX (US)

(72) Inventors: Zhi Li, Cypress, CA (US); Bopeng Gao; Daping Li; Jianwu Yang

(73) Assignee: Siemens Industry Software Inc., Plano, TX (US)

(21) Appl. No.: 18/863,522

(22) PCT Filed: Jun. 10, 2022
(86) PCT No.: PCT/CN2022/098140

§ 371 Date: Nov. 6, 2024

(51) Int. Cl. B29C 33/38; B29C 45/76

(52) U.S. Cl. CPC B29C 33/3835; B29C 45/7626; B29C 2945/76722; B29C 2945/76896; B29C 2945/76929

(57) ABSTRACT

A computing system may include an eject direction determination engine configured to determine an eject direction for an injection mold design, including by determining a set of candidate eject directions for the injection mold design, including a bounding box candidate eject direction determined based on a minimum bounding box of an object representative of a product to be manufactured through the injection mold design and selecting the eject direction for the injection mold design from the set of candidate eject directions based on eject direction determination criteria. The computing system may also include an eject direction application engine configured to set the determined eject direction for the injection mold design so that physical mold pieces constructed from the injection mold design are configured to separate from one another in the determined eject direction during an injection mold production process to manufacture the product.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports eject direction determinations for injection mold designs.

FIG. 2 shows an example determination of bounding box candidate eject directions by an eject direction determination engine.

FIG. 3 shows an example determination of a cylindrical axis candidate eject direction by the eject direction determination engine.

FIG. 4 shows an example determination of a bisecting plane candidate eject direction.

FIG. 5 shows an example determination of an eject direction for an injection mold design from a set of candidate eject directions through eject direction determination criteria.

FIG. 6 shows an example of logic that a system may implement to support eject direction determinations for injection mold designs.

FIG. 7 shows an example of a computing system that supports eject direction determinations for injection mold designs.

### DETAILED DESCRIPTION

Injection mold production may include processes in which a product is manufactured by injecting liquid (e.g., melted liquid plastic or molten plastic) into an injection mold, which then cools into the form of a solid product as shaped by the injection mold. In that regard, an injection mold may define or comprise a cavity that sets the shape, topology, structure, or various other physical characteristics of products constructed through injection mold productions. In some implementations, injection molds are formed by multiple mold pieces, sometimes referred to as (or including) design cores, cavities, or inserts. When these multiple mold pieces are aligned or combined together, an internal space (e.g., cavity) of the injection mold is formed that thus defines the solid shape that the injected liquid plastic will cool into. As such, injection molds (and the mold pieces that comprise the injection molds) may include internal surfaces that, in effect, define a mold cavity and product shape for injection mold production processes.

Modern injection mold productions may be an efficient mechanism to construct products quickly and in customized shapes, dimensions, and characteristics as defined by injection molds through the mold cavity formed by the multiple mold pieces. One aspect that impacts the cost, effectiveness, and product quality of injection mold production processes is an eject direction for mold pieces of an injection mold design. The eject direction for an injection mold design may specify a direction in which physical mold pieces that form a mold cavity separate from one another after the mold cavity is filled with injected material to form a physical product.

As the mold cavity formed by the mold pieces sets the shape of the constructed 3D product, the eject direction of the injection mold design may drive the actual shape of the different mold pieces. The 3D space of the mold cavity (and thus product shape) can be spliced along any 2D plane in the 3D space, which can form the boundary of two mold pieces and the eject direction of the injection mold design may be normal (e.g., perpendicular) to the 2D splicing plane. Thus, an eject direction for an injection mold design can be a configurable design parameter for an injection mold design that can greatly impact the cost of manufacture of the physical mold pieces, the manufacturing efficiency of injection-molded products constructed via a specific injection mold design, and even impact the product quality for the injection mold production process, e.g., through undercuts that prevent certain parts of the product from ejection from the mold after construction specific to a configured eject direction.

Typically, eject direction determinations are performed manually, relying on the expertise and experience of mold designers. Inexperienced designers may select eject directions that are non-optimal, resulting in increased undercuts and complexity in physical mold manufacture. Less optimal eject directions may also increase manufacturing costs requiring additional time, effort, and resources to address undercuts. Moreover, determination of improved eject directions can be a time-consuming process, and the mental capacity of even the most experienced designers cannot account for the near-infinite number of potential eject directions in a 3D space in order to determine ideal eject directions for the injection mold design of a given product to manufacture.

The disclosure herein may provide systems, methods, devices, and logic for eject direction determinations for injection mold designs. The intelligent eject direction determination technology described herein may provide capabilities to algorithmically determine eject directions for injection mold designs by determining multiple candidate eject directions based on different techniques. The candidate eject directions supported by the intelligent eject direction determination technology of the present disclosure may account for various factors in assessing an injection-molded product (e.g., a digital representation thereof), allowing for determination of eject directions for injection model designs with increased efficiency and effectiveness. For example, the intelligent eject direction determination technology may determine candidate eject directions based on minimum bounding boxes of a CAD object representative of an injection-molded product (which may thus form the shape of a mold cavity of an injection mold design), based on cylindrical axes of cylindrical or conical CAD faces of the CAD object, based on bisecting planes of selected pairs of CAD faces in the CAD object, determined through 3-point processing techniques for a selected face of the CAD object, or more.

The intelligent eject direction determination technology of the present disclosure may also provide for eject direction determination criteria by which selection of an eject direction can be made among a determined set of candidate eject directions. Such eject direction determination criteria may account for undercut areas for the candidate eject directions, which can increase the efficiency of injection mold production processes by reducing (and in some cases eliminating) the amount of undercut for injection-molded products manufactured according to the determined eject directions. The eject direction determination criteria may flexibly account for cylindrical axes as well, allowing for selection of a particular candidate eject direction determined based on a cylindrical axis even when another candidate eject direction has a lesser undercut area. The eject direction determination criteria of the present disclosure may thus provide increased flexibility and optimization for eject direction determinations for injection mold designs.

These and other intelligent eject direction determination features and technical benefits are described in greater detail herein.

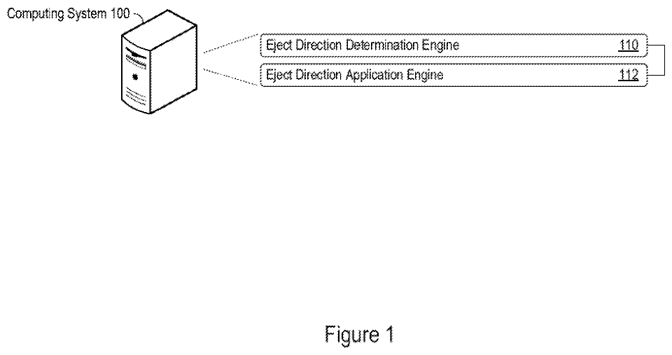

FIG. 1 shows an example of a computing system 100 that supports eject direction determinations for injection mold designs. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements a CAD application that supports generation of injection mold designs, including through determination of eject directions for injection mold designs.

As an example implementation to support any combination of the intelligent eject direction determination features described herein, the computing system 100 shown in FIG. 1 includes an eject direction determination engine 110 and an eject direction application engine 112. The computing system 100 may implement the engines 110 and 112 (including components thereof) in various ways, for example as hardware and programming. The programming for the engines 110 and 112 may take the form of processor-executable instructions stored on a non-transitory machine-readable storage medium and the hardware for the engines 110 and 112 may include a processor to execute those instructions. A processor may take the form of single processor or multi-processor systems, and in some examples, the computing system 100 implements multiple engines using the same computing system features or hardware components (e.g., a common processor or a common storage medium).

In operation, the eject direction determination engine 110 may determine an eject direction for an injection mold design, including by determining a set of candidate eject directions for the injection mold design. The set of candidate eject directions may include a bounding box candidate eject direction determined based on a minimum bounding box of an object representative of a product to be manufactured through the injection mold design. The eject direction determination engine 110 may further determine the eject direction for the injection mold design by selecting the eject direction for the injection mold design from the set of candidate eject directions based on eject direction determination criteria. In operation, the eject direction application engine 112 may set the determined eject direction for the injection mold design so that physical mold pieces constructed from the injection mold design are configured to separate from one another in the determined eject direction during an injection mold production process to manufacture the product.

These and other intelligent eject direction determination features and technical benefits are described in greater detail next. Various examples of candidate eject directions are described herein in turn, including bounding box candidate eject directions, cylindrical axis candidate eject directions, bisecting plane candidate eject directions, three-point candidate eject directions, and any other suitable candidate eject direction.

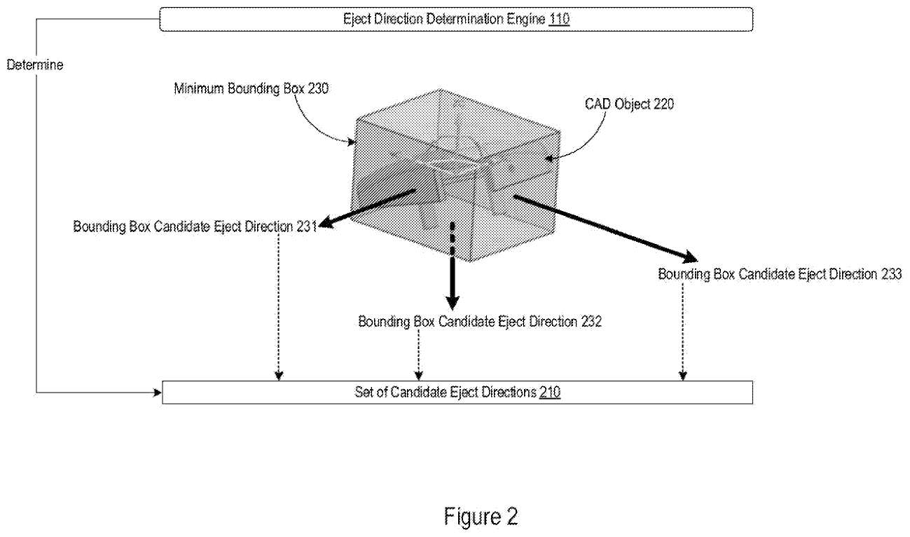

FIG. 2 shows an example determination of bounding box candidate eject directions by the eject direction determination engine 110. The eject direction determination engine 110 may process an object representative of a product to be manufactured through injection mold production processes. The object may be any digital representation of the physical product, such as a CAD object that represents a physical injection-molded product. An injection mold design may comprise a mold cavity with a 3D geometry that matches the external surface of the object (and thus the product). As such, the object may define the 3D geometry of the mold cavity of the injection mold design, and thus the 3D geometry of the multiple mold pieces that form the injection mold design. By processing the CAD object representative of the injection-molded product, the eject direction determination engine 110 may determine candidate eject directions for an injection mold design for the injection-molded product.

In the example of FIG. 2, the eject direction determination engine 110 processes the CAD object 220 in order to determine a set of candidate eject directions 210 for an injection mold design for the CAD object 220. As the surface geometry of the CAD object 220 may define the mold cavity of the injection mold design, the eject direction determination engine 110 may consider any direction (e.g., as represented as a 3D vector) in the 3D space of the CAD object 220 as a potential eject direction for the injection mold design. However, such a near-limitless number of eject direction possibilities would be near-impossible to quantitatively assess on a one-by-one basis, nor would it make sense to do so from an efficiency standpoint. The eject direction determination engine 110 may determine specific types of candidate eject directions to include in the set of candidate eject directions 210.

As one example, the eject direction determination engine 110 may determine bounding box candidate eject directions normal to the faces of a bounding box of the CAD object 220. In particular, the eject direction determination engine 110 may determine bounding box candidate eject directions normal to the faces of a minimum bounding box of the CAD object 220. For a given CAD object 220, there can exist multiple different bounding boxes that enclose the CAD object 220. The minimum bounding box for the CAD object may be the bounding box with the minimum volume that encloses CAD object 220. That is, no other bounding box for the CAD object 220 may have a lesser volume than the minimum bounding box for the CAD object 220. The eject direction determination engine 110 may employ and perform any suitable geometry process, technique, algorithm, or computation to determine the minimum bounding box for the CAD object 220, of which various modern techniques are possible and available. In the example of FIG. 2, the eject direction determination engine 110 determines the minimum bounding box 230 for the CAD object 220.

As the minimum bounding box 230 can be in the form of a 3D rectangular volume, the minimum bounding box 230 may include six (6) faces. The eject direction determination engine 110 may determine bounding box candidate eject directions from the minimum bounding box 230 as vectors normal to any number of the faces of the minimum bounding box 230. The eject direction determination engine 110 may thus determine multiple bounding box candidate eject directions from the minimum bounding box 230, such as the bounding box candidate eject directions 231, 232, and 233 shown in FIG. 2. Each of the bounding box candidate eject directions 231, 232, and 233 is normal to a different face of the minimum bounding box 230 of the CAD object 220.

In some implementations, the eject direction determination engine 110 may group pairs of candidate eject directions together when the direction vectors are opposite directions to one another. Such vectors or eject directions may also be referred to as opposite to one another or as opposite vectors. An illustrative example of opposite vectors are pairs of bounding box candidate eject directions normal to opposite faces of the minimum bounding box 230, such as bounding box candidate eject direction 231 and another bounding box candidate direction normal to the opposite face of the minimum bounding box 230 for the CAD object 220. In some implementations, the eject direction determination engine 110 may include three (3) pairs of bouncing box candidate eject directions determined from the minimum bounding box 230 in the set of candidate eject directions 210.

As another example feature, the eject direction determination engine 110 may selectively include some, but not all, of the determined bounding box candidate eject directions in the set of candidate eject directions 210. In some instances, the eject direction determination engine 110 may include only the bounding candidate eject direction normal (e.g., perpendicular) to the face(s) of the minimum bounding box 230 with the greatest area as part of the set of candidate eject directions 210. As the minimum bounding box 230 may include opposite faces each with the same area, the eject direction determination engine 110 may include a pair of bounding box candidate eject directions for the opposite faces of the minimum bounding box 230 with the greatest area. Such bounding box candidate eject directions may be paired together since their vector directions are opposite to another as being normal to opposite faces of the minimum bounding box 230.

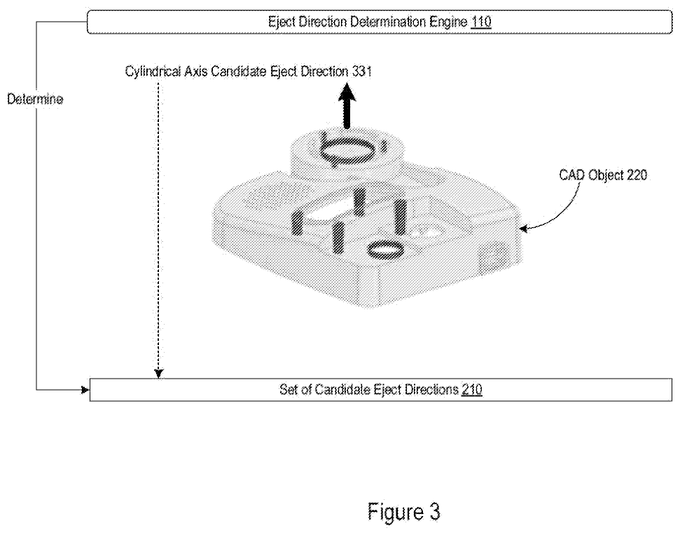

In any of the ways described herein, the eject direction determination engine 110 may determine bounding box candidate eject directions from minimum bounding boxes of CAD objects representative of products to be manufactured through injection mold designs. The eject direction determination engine 110 may include any number of the determined bounding box candidate eject directions in a set of candidate eject directions from which to select an eject direction for the injection mold design. Another type of candidate eject direction supported by the intelligent eject direction determination technology of the present discloser is a cylindrical axis candidate eject direction, example features of which are described next with reference to FIG. 3.

FIG. 3 shows an example determination of a cylindrical axis candidate eject direction by the eject direction determination engine 110. Many types of physical products produced via injection mold production processes can include holes or cylindrical surfaces. If the eject direction of the injection mold design for such products is not aligned along (e.g., normal to) the holes of the product, then such holes and cylindrical surfaces will become undercuts in the injection mold. As used herein, an undercut may refer to any portion of a product for which ejection from an injection mold is prevented after construction. Understood another way, undercuts may refer to features, portions, or elements of an injection-molded product that prevent the products ejection from the mold. Examples of undercuts can include protrusions, holes, cavities, and recessed part area that are stuck or otherwise blocked by the injection mold during the ejection of injection mold production process.

As part ejection is performed along a given eject direction, it can be appreciated that different eject directions for an injection mold design can result in different undercut portions for the same injection-molded product. Thus, the different candidate eject directions determined for an injection mold design for an injection-molded product will each be characterized by different undercut areas, as varying directions of ejection can cause some portions of the product to now be undercut as compared to other eject directions and vice versa. This can be relevant as any candidate eject direction determined by the eject direction determination engine 110 that is not normal (e.g., not perpendicular) to hole or cylinder openings in an injection-molded product will result in that the hole or cylinder becoming an undercut, as it will be obscured and prevent ejection of the injection-molded product along an eject direction that is not normal to the hole or cylinder opening.

Accordingly, the eject direction determination engine 110 may determine cylindrical axis candidate eject directions and include determined cylindrical axis candidate eject directions as part of a set of candidate eject directions for an injection mold design. To do so, the eject direction determination engine 110 may identify cylindrical-type faces in a CAD object for an injection mold design and extract the cylindrical axis of any identified cylinder faces in the CAD object. Cylindrical faces may be a specific type of face supported by many CAD design applications, and a cylindrical axis of such cylindrical faces can be user-specified or otherwise designed by CAD applications. Such CAD faces may be characterized as cylinders, cones, or in any other consistent manner, and include a cylindrical axis as a defined property of the CAD face.

In FIG. 3, the eject direction determination engine 110 identifies multiple different cylinder faces in the CAD object 220 and may extract a respective cylindrical axis for each of the identified cylinder faces. In the particular example shown in FIG. 3, various cylinder faces are visually emphasized in the illustrated CAD object 220. The cylinder faces of the CAD object 220 in this example each have a hole opening along a same orientation, and thus the cylindrical axis of each of the cylindrical faces of the CAD object 220 are identical in direction. As such, the eject direction determination engine 110 may determine a single cylindrical axis candidate eject direction 331 for the CAD object 220 in the direction of the cylindrical axes of the multiple cylinder faces of the CAD object 220. Then, the eject direction determination engine 110 may include the cylindrical axis candidate eject direction 331 as part of the set of candidate eject directions 210 of an injection mold design for the CAD object 220.

In some instances, a CAD object may include cylinder faces aligned in different orientations in a 3D space, and thus have cylindrical axes that differ in direction. In such cases, the eject direction determination engine 110 may determine multiple different cylindrical axis candidate eject directions for the CAD object, e.g., one for each unique direction among the cylindrical axes of faces of the CAD object. The eject direction determination engine 110 may include any number of the determined cylindrical axis candidate eject directions in the set of candidate eject directions. In some implementations, the eject direction determination engine 110 may assess the multiple cylindrical axis candidate eject directions based on undercut area, for example doing so by summing the area of any cylinder face(s) that are aligned with each given cylindrical axis candidate eject directions. For any cylinder faces of a CAD object with cylindrical axes in the same direction (or within a threshold difference, e.g., within a 1° difference or any suitable or configurable difference), the eject direction determination engine 110 may group such cylinder faces together for a same cylindrical axis candidate eject direction.

The area of all of the cylinder faces grouped together for a particular cylindrical axis candidate eject direction may be referred to as the cylinder face area or undercut area for that particular cylindrical axis candidate eject direction. The greater the cylinder face area of the grouped cylinder faces for a given cylindrical axis candidate eject direction, the greater amount of undercut area that can be eliminated by selecting the given cylindrical axis candidate eject direction as the eject direction for an injection mold design. As such, the eject direction determination engine 110 may, in some implementations, determine to include a cylindrical axis candidate eject direction with a greatest cylinder face area in the set of candidate eject directions and excluding any other cylindrical axis candidate eject directions from the set of candidate eject directions for an injection mold design.

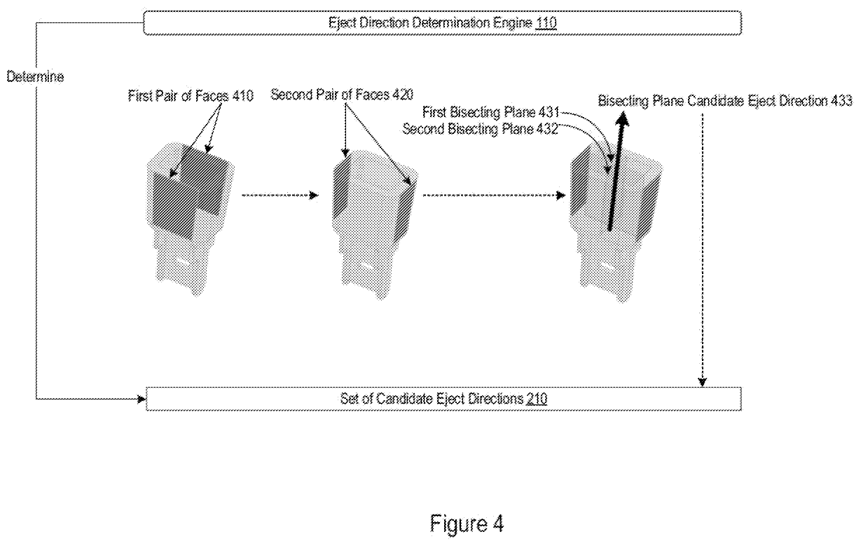

In any of the ways described herein, the eject direction determination engine 110 may determine cylindrical axis candidate eject directions from CAD objects representative of products to be manufactured through injection mold designs. The eject direction determination engine 110 may include any number of the determined cylindrical axis candidate eject directions in a set of candidate eject directions from which to select an eject direction for the injection mold design. As yet another type of candidate ejection directions, the eject direction determination engine 110 may determine bisecting plane candidate eject directions, example features of which are described next with reference to FIG. 4.

FIG. 4 shows an example determination of a bisecting plane candidate eject direction. Bisecting plane candidate eject directions may be determined via algorithmic analysis or through user-specification, the latter of which can allow a user to override or control candidate eject direction determinations through specific inputs and selections. In the case of bisecting plane candidate eject directions, multiple pairs of faces of a CAD object can be selected through which a candidate eject direction for an injection mold design can be determined.

To illustrate through FIG. 4, the eject direction determination engine 110 identifies a first pair of faces 410 of a CAD object representative of a product to be manufactured through an injection mold design as well as a second pair of faces 420 of the CAD object. The pairs of faces 410 and 420 can be specified via user-input. As another implementation example, the eject direction determination engine 110 may algorithmically determine the pairs of faces 410 and 420 by processing the CAD object, e.g., to determine faces of the CAD object that meet pairing criteria. As an illustrative example, the pairing criteria may specify identification of face pairs that are parallel to one another and with face areas within a size threshold from one another. The pairing criteria may further specify that different face pairs to be orthogonal to one another. Any suitable pairing criteria is supported by the intelligent eject direction determination technology of the present disclosure.

From the specified pairs of faces in a CAD object, the eject direction determination engine 110 may determine bisecting planes. In FIG. 4, the eject direction determination engine 110 determines a first bisecting plane 431 for the first pair of faces 410 of the CAD object, doing so in accordance with any suitable algorithm, 3D process, or computation flow to determine a bisection of two faces. For two parallel faces, the eject direction determination engine 110 may determine the bisecting plane as also parallel to the two parallel faces and equidistant to each of the parallel faces, thus bisecting (e.g., equally dividing in two) the space between the parallel faces. In FIG. 4, the eject direction determination engine 110 further determines a second bisecting plane 432 for the second pair of faces 420 of the CAD object.

The eject direction determination engine 110 may then determine the bisecting plane candidate eject direction 433 from an intersection of the first bisecting plane 431 and the second bisecting plane 432. As the intersection between planes may be in the form of a line or line segment, the eject direction determination engine 110 may determine the bisecting plane candidate eject direction 433 as a vector along either direction of the line segment (or, in some cases both directions in which case the eject direction determination engine 110 determines a pair of bisecting plane candidate eject directions that opposite vectors to one another). The eject direction determination engine 110 may thus determine the bisecting plane candidate eject direction 433 for a CAD object. In some implementations, the eject direction determination engine 110 may include the bisecting plane candidate eject direction 433 in the set of candidate eject directions 210 for an injection mold design.

Through a bisecting plane candidate ejection, the eject direction determination engine 110 may ensure that a given candidate eject direction is orthogonal to at least multiple specified pairs of faces in the CAD object. In that regard, the eject direction determination engine 110 may prioritize specific CAD faces in determination of a candidate eject direction, which may allow for customizable weighting of specific portions of a CAD object in eject direction determinations. For injection-molded products with rib structures, such bisecting plane candidate eject directions may be particularly useful in order to ensure that specific ribs of the CAD object are accounted for in eject direction determinations to increase efficiency and product quality for ribbed injection-molded products.

As a further type of candidate ejection directions supported by the present disclosure, the eject direction determination engine 110 may determine three-point candidate eject directions for an injection mold design. For some representations of CAD objects designed to represent an injection-molded product, specific face characteristics cannot be easily defined or specified. For instance, faces in B-spline surfaces, boundary representations (BREPs), and various other representation forms of CAD objects may not support or allow for distinct definition of cylindrical axes of surface elements, thus deeming determination of cylindrical axis candidate eject directions difficult for cylindrical shapes and holes of the CAD object.

The eject direction determination engine 110 may implement three-point candidate eject direction determinations to computationally determine eject directions that correspond to, approximate, or otherwise align with cylindrical axis candidate eject directions even when cylindrical axes are not readily obtainable. To do so, the eject direction determination engine 110 may identify a selected face of a CAD object representative of an injection-molded product to be manufactured through an injection mold design. The selected face may be user-selected, e.g., a user-selected hole, cone, or cylinder structure in the CAD object.

From the selected face, the eject direction determination engine 110 may determine three points on the selected face of the CAD object, for example through a random selection. Then, the eject direction determination engine 110 may determine three tangential planes, each of the tangential planes tangent to one of the three points on the selected face. The eject direction determination engine 110 may then determine a first bisecting plane for a first pair of the three tangential planes and a second bisecting plane for a second pair of the three tangential planes, the first pair different from the second pair (e.g., not an identical pair). With three distinct pairs of tangential planes possible from the three tangential planes, the eject direction determination engine 110 may determine bisecting planes for (any) two pairs out of the three distinct pairs.

Then, the eject direction determination engine 110 may determine the thee-point candidate eject direction from an intersection of the first bisecting plane and the second bisecting plane, e.g., as a vector along either direction (or both directions) of the line segment intersection between the two bisecting planes. Accordingly, the three-point candidate eject direction may serve as a direction axis specific to a selected face of the CAD object, and the eject direction determination engine 110 may flexibly support specific eject direction candidates for specific faces of a CAD object.

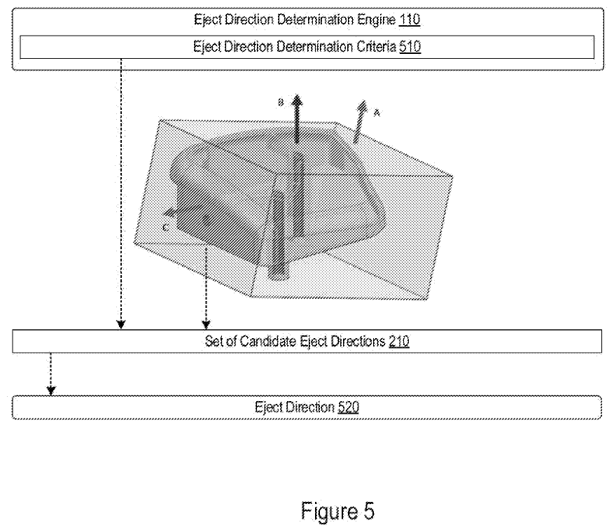

While some examples of candidate eject directions are described herein, including bounding box, cylindrical axis, bisecting plane, and three-point candidate eject directions, the eject direction determination engine 110 may determine any suitable candidate eject directions for consideration for an injection mold design. The various candidate eject directions described herein may provide a limited set of candidates for consideration, each with specific benefits as a possible eject direction for an injection mold design. Determination of an eject direction from candidate eject directions may be performed via eject direction determination criteria, as described next with reference to FIG. 5.

FIG. 5 shows an example determination of an eject direction for an injection mold design from a set of candidate eject directions through eject direction determination criteria. The eject direction determination engine 110 may apply eject direction determination criteria 510 to determine an eject direction 520 of an injection mold design for a CAD object representative of an injection-molded product. The eject direction determination engine 110 may apply the eject direction determination criteria 510 to a set of candidate eject directions 210 determined for a CAD object. In the example of FIG. 5, the set of candidate eject directions may include a bounding box candidate direction labeled as “A” and two cylindrical axis candidate eject directions labeled as “B” and “C”.

The eject direction determination criteria 510 may specify any criterion, condition, or metric by which to compare multiple candidate eject directions and select an eject direction 520 for an injection mold design from the multiple candidate eject directions. As one example, the eject direction determination criteria 510 may specify selecting, as the eject direction 520 for the injection mold design, a candidate eject direction from the set of candidate eject directions 210 with a lowest undercut area. Determination of undercut area for candidate eject directions may be performed in any suitable way, e.g., through any modern processing techniques performed along each of the candidate eject directions to compute respective undercut areas for each of the candidate eject directions. By minimizing undercut area, the eject direction determination criteria 510 may improve the efficiency of injection mold production processes for the injection mold design.

As another example, the eject direction determination criteria 510 may weight cylindrical axis candidate eject directions with increased priority. In doing so, the eject direction determination criteria 510 may specify selection of a cylindrical axis candidate eject direction for an injection mold design even when the cylindrical axis candidate eject direction does not have the lowest undercut area among the set of candidate eject directions 210. Such conditions may trigger when the cylindrical axis candidate eject direction has an undercut area within a threshold difference from the candidate eject direction with the lowest undercut area (e.g., within a 10% difference).

To illustrate through FIG. 5, the bounding box candidate eject direction “A” may have an undercut area of “342” and the cylindrical axis candidate eject direction “B” may have an undercut area of “350”. In this case, the eject direction determination criteria 510 may specify selecting the cylindrical axis candidate eject direction “B” as the eject direction 520 for an injection mold design, as the undercut area of cylindrical axis candidate eject direction “B” is within the 10% threshold difference from the undercut area of bounding box candidate eject direction “A”. In such examples, the eject direction determination criteria 510 may specify selecting, as the eject direction 520 for an injection mold design, a cylindrical axis candidate eject direction with an undercut area that is within a threshold difference to an undercut area of a candidate eject direction with a lowest undercut area among the set of candidate eject directions 210.

As yet another example feature, the eject direction determination criteria 510 may set override scenarios in which a particular candidate eject direction is selected as the eject direction 520 for an injection mold design. For instance, the eject direction determination criteria 510 may set user-inputs as overriding and specify any candidate eject direction determined based on the user-inputs be selected as the eject direction 520 for the injection mold design. For bisecting plane candidate eject directions in which a user selects multiple pairs of faces of a CAD object, the eject direction determination criteria 510 specify that the bisecting plane candidate eject direction be determined as the eject direction 520 for the injection mold design without consideration of any other candidate eject directions (and in some implementations, without even determining any other candidate eject directions). In a consistent manner, the eject direction determination criteria 510 may specify selection of a three-point candidate eject direction for a user-selected face of a CAD object as the eject direction 520 for the injection mold design, overriding any other candidate eject directions based on the user selection of the CAD face for three-point eject direction determination.

In some implementations, the eject direction determination criteria 510 may distinctively assess multiple candidate eject directions of the same type, such as when multiple candidate eject directions of the same type have the same undercut area. As one example, two different cylindrical axis candidate eject directions have an identical amount of undercut area which is the lowest undercut area in the set of candidate eject directions 210. The eject direction determination criteria 510 may select among the two cylindrical axis candidate eject directions via a secondary criterion as to which cylindrical axis candidate eject direction has a lesser number of corresponding cylinder faces that form the cylinder face area (and thus undercut area). The cylindrical axis candidate eject direction that satisfies this secondary criterion will be selected as the eject direction 520 for the injection mold design in this example.

The eject direction determination criteria 510 may support selection of the eject direction 520 from among a candidate eject direction and its opposite direction. For instance, the set of candidate eject directions 210 may include a pair of candidate eject directions that are opposite vectors to one another, and which satisfy the eject direction determination criteria 510 for lowest undercut area. The undercut area for this pair of candidate eject directions may be identical, as undercut area along a particular vector direction will be identical for the opposite vector direction. Selection of a particular direction (or its opposite) may be relevant as injection mold designs can include a fixed mold piece that stays in position during part ejection and move mold piece that is moved along the eject direction during part ejection in an injection mold production process. In some instances, the eject direction 520 determined by the eject direction determination engine 110 points to the fixed mold piece, and in other instances the opposite.

The eject direction determination criteria 510 may specify evaluation of opposite vectors based on angles between faces of a CAD object representative of an injection-molded product. As an illustrative example, through FIG. 5, the eject direction determination criteria 510 may select between cylindrical axis candidate ejection direction “B” and its opposite vector. In support of such a comparison, the eject direction determination engine 110 may identify the faces of the CAD object and group the faces into two distinct groups based on an angle between faces and cylindrical axis candidate ejection direction “B”. If the angle of a given face of the CAD object and cylindrical axis candidate ejection direction “B” is >90°, the eject direction determination engine 110 may assign the given face to a first group, and otherwise to a second group if this angle condition is not satisfied. Comparison of angles between a face and candidate eject direction may be performed based on any suitable vector that characterizes the face (e.g., cylindrical axis, other designated face axis, normal vector, etc.).

Then, the eject direction determination engine 110 may sum the areas of the faces in the first group and the second group. If the summed area of the second group is greater than the summed area of the first group, the eject direction determination engine 110 may select the cylindrical axis candidate ejection direction “B” as the eject direction 520 for the injection mold design. If otherwise, the eject direction determination engine 110 may select the opposite vector of the cylindrical axis candidate ejection direction “B” as the eject direction 520 for the injection mold design. In such a way, the eject direction determination engine 110 may select between oppositive vectors to determine an eject direction for an injection mold design.

In any of the various ways described herein, the eject direction determination engine 110 may apply eject direction determination criteria 510 to select an eject direction 520 for an injection mold design. While many intelligent eject direction determination features have been described herein through illustrative examples presented through various figures, the eject direction determination engine 110 or the eject direction application engine 112 may implement any combination of the intelligent eject direction determination technology described herein.

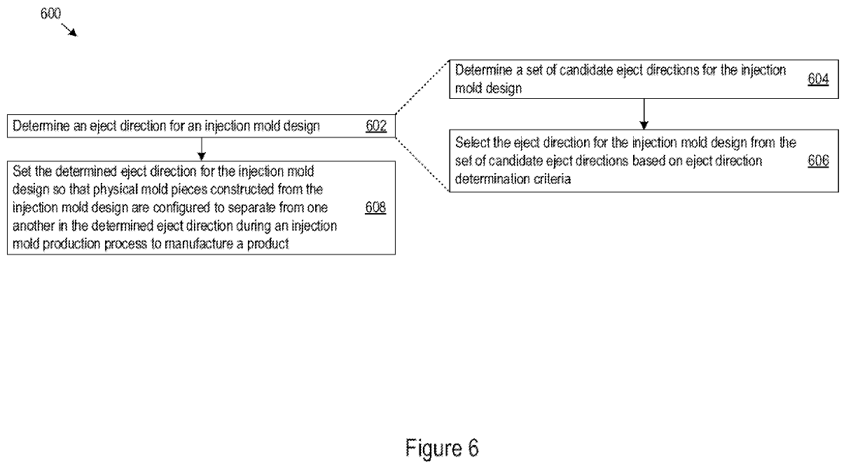

FIG. 6 shows an example of logic 600 that a system may implement to support eject direction determinations for injection mold designs. For example, the computing system 100 may implement the logic 600 as hardware, executable instructions stored on a machine-readable medium, or as a combination of both. The computing system 100 may implement the logic 600 via the eject direction determination engine 110 and the eject direction application engine 112, through which the computing system 100 may perform or execute the logic 600 as a method to support intelligent eject direction determination. The following description of the logic 600 is provided using the eject direction determination engine 110 and the eject direction application engine 112 as examples. However, various other implementation options by computing systems are possible.

In implementing the logic 600, the eject direction determination engine 110 may determine an eject direction for an injection mold design (602), including by determining a set of candidate eject directions for the injection mold design (604). In doing so, the eject direction determination engine 110 may determine the set of candidate eject directions to include a bounding box candidate eject direction determined based on a minimum bounding box of an object representative of a product to be manufactured through the injection mold design. Any additional or alternative candidate eject directions as described herein may be determined by the eject direction determination engine 110, such as cylindrical axis candidate eject directions, bisecting plane candidate eject directions, three-point candidate eject directions, etc. In determining the eject direction, the eject direction determination engine 110 may select the eject direction for the injection mold design from the set of candidate eject directions based on eject direction determination criteria (606), including according to any of the various features of eject direct direction determination criteria as described herein. In implementing the logic 600, the eject direction application engine 112 may set the determined eject direction for the injection mold design so that physical mold pieces constructed from the injection mold design are configured to separate from one another in the determined eject direction during an injection mold production process to manufacture the product (608).

The logic 600 shown in FIG. 6 provides an illustrative example by which a computing system 100 may support eject direction determinations for injection mold designs. Additional or alternative steps in the logic 600 are contemplated herein, including according to any of the various features described herein for the eject direction determination engine 110, the eject direction application engine 112, or any combinations thereof.

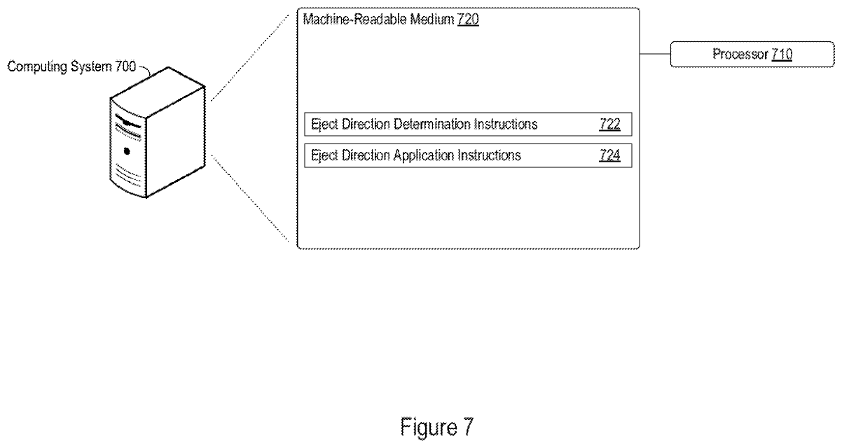

FIG. 7 shows an example of a computing system 700 that supports eject direction determinations for injection mold designs. The computing system 700 may include a processor 710, which may take the form of a single or multiple processors. The processor(s) 710 may include a central processing unit (CPU), microprocessor, or any hardware device suitable for executing instructions stored on a machine-readable medium. The computing system 700 may include a machine-readable medium 720. The machine-readable medium 720 may take the form of any non-transitory electronic, magnetic, optical, or other physical storage device that stores executable instructions, such as the eject direction determination instructions 722 and the eject direction application instructions 724 shown in FIG. 7. As such, the machine-readable medium 720 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 700 may execute instructions stored on the machine-readable medium 720 through the processor 710. Executing the instructions (e.g., the eject direction determination instructions 722 and/or the eject direction application instructions 724) may cause the computing system 700 to perform any of the intelligent eject direction determination features described herein, including according to any of the features of the eject direction determination engine 110, the eject direction application engine 112, or combinations of both.

For example, execution of the eject direction determination instructions 722 by the processor 710 may cause the computing system 700 to determine an eject direction for an injection mold design, including by determining a set of candidate eject directions for the injection mold design, doing so in any of the ways described herein, and selecting the eject direction for the injection mold design from the set of candidate eject directions based on eject direction determination criteria. Execution of the eject direction application instructions 724 by the processor 710 may cause the computing system 700 to set the determined eject direction for the injection mold design so that physical mold pieces constructed from the injection mold design are configured to separate from one another in the determined eject direction during an injection mold production process to manufacture a product.

Any additional or alternative intelligent eject direction determination features as described herein may be implemented via the eject direction determination instructions 722, eject direction application instructions 724, or a combination of both.

The systems, methods, devices, and logic described above, including the eject direction determination engine 110 and the eject direction application engine 112, may be implemented in many different ways in many different combinations of hardware, logic, circuitry, and executable instructions stored on a machine-readable medium. For example, the eject direction determination engine 110, the eject direction application engine 112, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the eject direction determination engine 110, the eject direction application engine 112, or combinations thereof.

The processing capability of the systems, devices, and engines described herein, including the eject direction determination engine 110 and the eject direction application engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
determining an eject direction for an injection mold design, including by:
determining a set of candidate eject directions for the injection mold design, including a bounding box candidate eject direction determined based on a minimum bounding box of an object representative of a product to be manufactured through the injection mold design; and
selecting the eject direction for the injection mold design from the set of candidate eject directions based on eject direction determination criteria; and
setting the determined eject direction for the injection mold design so that physical mold pieces constructed from the injection mold design are configured to separate from one another in the determined eject direction during an injection mold production process to manufacture the product.

2. The method of claim 1, comprising determining multiple bounding box candidate eject directions, wherein each of the multiple bounding box candidate eject directions is normal to a different face of the minimum bounding box of the object representative of the product to be manufactured through the injection mold design.

3. The method of claim 1, comprising determining the set of candidate eject directions to further include a cylindrical axis candidate eject direction that aligns with a cylindrical axis of a cylinder face of object representative of the product to be manufactured through the injection mold design.

4. The method of claim 1, wherein the eject direction determination criteria specifies selecting a candidate eject direction with a lowest undercut area.

5. The method of claim 3, wherein the eject direction determination criteria specifies selecting the cylindrical axis candidate eject direction when the cylindrical axis candidate has an undercut area that is within a threshold difference to an undercut area of a candidate eject direction with a lowest undercut area among the set of candidate eject directions.

6. The method of claim 1, comprising determining the set of candidate eject directions to include a bisecting plane candidate eject direction determined by:
determining a first bisecting plane for a first pair of faces of the object representative of the product to be manufactured through the injection mold design;
determining a second bisecting plane for a second pair of faces of the object representative of the product to be manufactured through the injection mold design; and
determining the bisecting plane candidate eject direction from an intersection of the first bisecting plane and the second bisecting plane.

7. The method of claim 1, determining the set of candidate eject directions to include a three-point candidate eject direction determined by:
determining three points on a selected face of the object representative of the product to be manufactured through the injection mold design;
determining three tangential planes, each of the tangential planes tangent to one of the three points on the selected face;
determining a first bisecting plane for a first pair of the three tangential planes and a second bisecting plane for a second pair of the three tangential planes, the first pair different from the second pair; and
determining the thee-point candidate eject direction from an intersection of the first bisecting plane and the second bisecting plane.

8. A system comprising:
a processor; and
a non-transitory machine-readable medium comprising instructions that, when executed by the processor, cause a computing system to:
determine an eject direction for an injection mold design, including by:
determining a set of candidate eject directions for the injection mold design, including a bounding box candidate eject direction determined based on a minimum bounding box of an object representative of a product to be manufactured through the injection mold design; and
selecting the eject direction for the injection mold design from the set of candidate eject directions based on eject direction determination criteria; and
set the determined eject direction for the injection mold design so that physical mold pieces constructed from the injection mold design are configured to separate from one another in the determined eject direction during an injection mold production process to manufacture the product.

9. The system of claim 8, wherein the instructions, when executed, cause the computing system to determine multiple bounding box candidate eject directions, wherein each of the multiple bounding box candidate eject directions is normal to a different face of the minimum bounding box of the object representative of the product to be manufactured through the injection mold design.

10. The system of claim 8, wherein the instructions, when executed, cause the computing system eject to determine the set of candidate eject directions to further include a cylindrical axis candidate eject direction that aligns with a cylindrical axis of a cylinder face of the object representative of the product to be manufactured through the injection mold design.

11. The system of claim 8, wherein the eject direction determination criteria specifies selecting a candidate eject direction with a lowest undercut area.

12. The system of claim 10, wherein the eject direction determination criteria specifies selecting the cylindrical axis candidate eject direction when the cylindrical axis candidate has an undercut area that is within a threshold difference to an undercut area of a candidate eject direction with a lowest undercut area among the set of candidate eject directions.

13. The system of claim 8, wherein the instructions, when executed, cause the computing system to determine the set of candidate eject directions to include a bisecting plane candidate eject direction determined by:
determining a first bisecting plane for a first pair of faces of the object representative of the product to be manufactured through the injection mold design;
determining a second bisecting plane for a second pair of faces of the object representative of the product to be manufactured through the injection mold design; and
determining the bisecting plane candidate eject direction from an intersection of the first bisecting plane and the second bisecting plane.

14. The system of claim 8, wherein the instructions, when executed, cause the computing system to determine the set of candidate eject directions to include a three-point candidate eject direction determined by:
determining three points on a selected face of the object representative of the product to be manufactured through the injection mold design;
determining three tangential planes, each of the tangential planes tangent to one of the three points on the selected face;
determining a first bisecting plane for a first pair of the three tangential planes and a second bisecting plane for a second pair of the three tangential planes, the first pair different from the second pair; and
determining the thee-point candidate eject direction from an intersection of the first bisecting plane and the second bisecting plane.

15. A non-transitory machine-readable medium comprising instructions that, when executed by a processor, cause a computing system to:
determine an eject direction for an injection mold design, including by:
determining a set of candidate eject directions for the injection mold design, including a bounding box candidate eject direction determined based on a minimum bounding box of an object representative of a product to be manufactured through the injection mold design; and
selecting the eject direction for the injection mold design from the set of candidate eject directions based on eject direction determination criteria; and
set the determined eject direction for the injection mold design so that physical mold pieces constructed from the injection mold design are configured to separate from one another in the determined eject direction during an injection mold production process to manufacture the product.

16. The non-transitory machine-readable medium of claim 15, wherein the instructions, when executed, cause the computing system to determine multiple bounding box candidate eject directions, wherein each of the multiple bounding box candidate eject directions is normal to a different face of the minimum bounding box of the object representative of the product to be manufactured through the injection mold design.

17. The non-transitory machine-readable medium of claim 15, wherein the instructions, when executed, cause the computing system to determine the set of candidate eject directions to further include a cylindrical axis candidate eject direction that aligns with a cylindrical axis of a cylinder face of the object representative of the product to be manufactured through the injection mold design.

18. The non-transitory machine-readable medium of claim 15, wherein the eject direction determination criteria specifies selecting a candidate eject direction with a lowest undercut area.

19. The non-transitory machine-readable medium of claim 15, wherein the instructions, when executed, cause the computing system to determine the set of candidate eject directions to include a bisecting plane candidate eject direction determined by:
determining a first bisecting plane for a first pair of faces of the object representative of the product to be manufactured through the injection mold design;
determining a second bisecting plane for a second pair of faces of the object representative of the product to be manufactured through the injection mold design; and
determining the bisecting plane candidate eject direction from an intersection of the first bisecting plane and the second bisecting plane.

20. The non-transitory machine-readable medium of claim 15, wherein the instructions, when executed, cause the computing system to determine the set of candidate eject directions to include a three-point candidate eject direction determined by:
determining three points on a selected face of the object representative of the product to be manufactured through the injection mold design;
determining three tangential planes, each of the tangential planes tangent to one of the three points on the selected face;
determining a first bisecting plane for a first pair of the three tangential planes and a second bisecting plane for a second pair of the three tangential planes, the first pair different from the second pair; and
determining the thee-point candidate eject direction from an intersection of the first bisecting plane and the second bisecting plane.
